(19) United States
(12) Patent Application Publication
(10) Pub. No.: US 2010/0122831 A1
(43) Pub. Date: May 20, 2010

(54) SHIELD CONDUCTOR

(75) Inventor: Kunihiko Watanabe, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., Yokkaichi-shi (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 12/451,523

(22) PCT Filed: Aug. 22, 2008
(86) PCT No.: PCT/JP2008/064988

§ 371 Date: Nov. 17, 2009

(30) Foreign Application Priority Data
Aug. 22, 2007 (JP) 2007-216388

(51) Int. Cl. H01B 9/02

(52) U.S. Cl. 174/107

(57) ABSTRACT

This invention provides a shield conductor having improved heat dissipation property. The present invention relates to a shield conductor comprising: a wire, a shielding layer for enwrapping the outer circumference of the wire, and a sleeve pipe for housing the wire and the shielding layer, wherein the outer circumference of the wire tightly adheres to the shielding layer, while the shielding layer tightly adheres to the inner circumference of the sleeve pipe.

### TECHNICAL FIELD

The present invention relates to a shield conductor.

### BACKGROUND ART

Conventionally, the shield conductor disclosed in Patent Literature 1 has been well-known. This shield conductor comprises multiple wires, a braided wire enwrapping the wires, and a corrugated tube enwrapping the wires and the braided wire. The above-mentioned shield conductor is mounted in an electric vehicle and electrically connects between equipments such as an inverter and a motor.

[Patent literature 1]: Japanese Unexamined Patent Publication No. 2004-172476

### DISCLOSURE OF THE INVENTION

In the shield conductor according to the above configuration, heat generated from the wires at the time of electricity application is transmitted sequentially from the wire, to the braided wire, and to the corrugated tube, and then is released from the corrugated tube to the outside of the shield conductor. However, according to the above configuration, an air layer exists between the wire and the braided wire, and between the braided wire and the corrugated tube. This air layer has a relatively low heat conductivity, therefore heat generated from the wires remains inside of the corrugated tube, and might cause a temperature rise of the wires.

In a case where the upper limit of the temperature rise value of the wires has been decided, the heating value at the time of electricity application may be lowered by enlarging the diameter of the wire. However, this method causes the enlargement of the entire shield conductor, and cannot therefore be employed.

This invention has been completed based on the above circumstances, and its purpose is to provide a shield conductor having improved heat dissipation property.

The present invention relates to a shield conductor comprising: a wire, a shielding layer for enwrapping the outer circumference of the wire, and a sleeve pipe for housing the wire and the shielding layer, wherein the outer circumference of the wire tightly adheres to the shielding layer, while the shielding layer tightly adheres to the inner circumference of the sleeve pipe.

With the configuration of the present invention, heat generated from the wire when electrical current is fed to the wire is transmitted from the wire to the shielding layer, and to the sleeve pipe, and then is released from the sleeve pipe to the outside of the shield conductor. With the configuration of the present invention, the outer circumference of the wire and the shielding layer tightly adhere each other, and moreover, the shielding layer and the inner circumference of the sleeve pipe tightly adhere each other. Accordingly, the heat conductivity from the wire to the sleeve pipe can be improved, thereby improving the heat dissipation property of the shield conductor.

### BRIEF DESCRIPTION OF THE DRAWINGS

FIG. 1 is a perspective view showing a shield conductor according to Embodiment 1;

FIG. 2 is a perspective view of a plate member;

FIG. 3 is an elevation view of the plate member;

FIG. 4 is a perspective view of the manufacturing process of the shield conductor;

FIG. 5 is a perspective view of the manufacturing process of the shield conductor;

FIG. 6 is a cross-sectional elevation view of the manufacturing process of the shield conductor;

FIG. 7 is a cross-sectional elevation view of the shield conductor;

FIG. 8A is a cross-sectional view showing a state before a pin is inserted into an insertion hole;

FIG. 8B is a cross-sectional view showing a state of the pin on the way to be inserted into the insertion hole;

FIG. 8C is a cross-sectional view showing a state after the pin has been inserted into the insertion hole;

FIG. 9 is a perspective view showing a shield conductor according to Embodiment 2;

FIG. 10 is a cross-sectional elevation view of the shield conductor;

FIG. 11 is a cross-sectional elevation view showing a shield conductor according to Embodiment 3;

FIG. 12 is a cross-sectional elevation view showing a shield conductor according to Embodiment 4.

### DESCRIPTION OF SYMBOLS

10 . . . shield conductor
11 . . . sleeve pipe
12 . . . braided wire (shielding layer)
13 . . . wire
16 . . . housing member
17 . . . plate member
18 . . . groove
22 . . . pin (pressing member)
26 . . . first plate member
27 . . . second plate member
28 . . . first groove
29 . . . second groove

### BEST MODE FOR CARRYING OUT THE INVENTION

### Embodiment 1

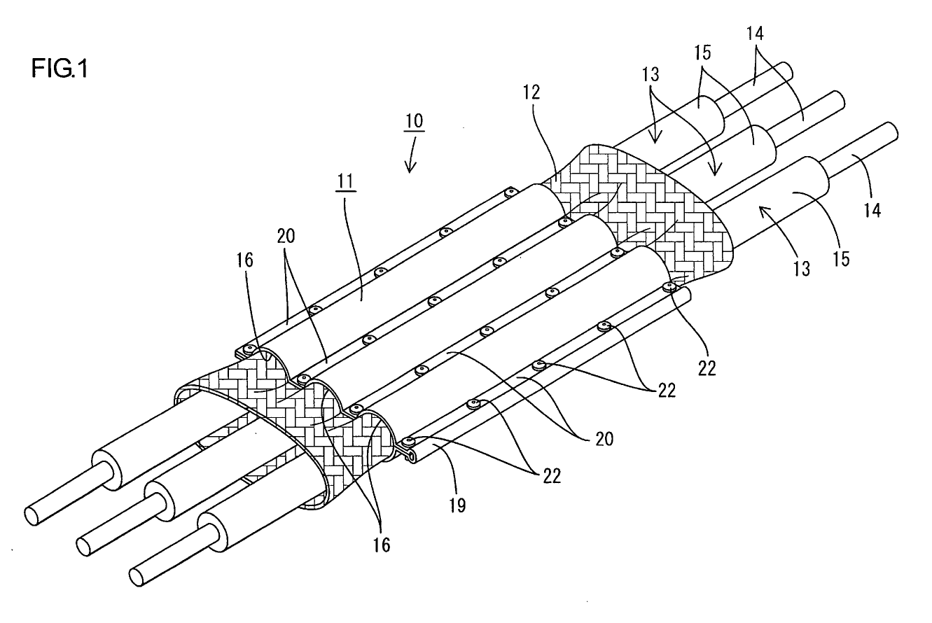

In reference to FIGS. 1 to 8, Embodiment 1 of the present invention is described. As shown in FIG. 1, the shield conductor 10 according to the present embodiment is constituted by housing three wires 13 enwrapped by a braided wire 12 (corresponding to a shielding layer) in a sleeve pipe 11. The shield conductor 10 is mounted in, for example, a vehicle (not shown) such as an electric vehicle and a hybrid vehicle, and electrically connects between equipments such as an inverter device (not shown) and a motor (not shown). The shield conductor 10 is fitted into the vehicle by a holding member (not shown) such as, for example, a clamp.

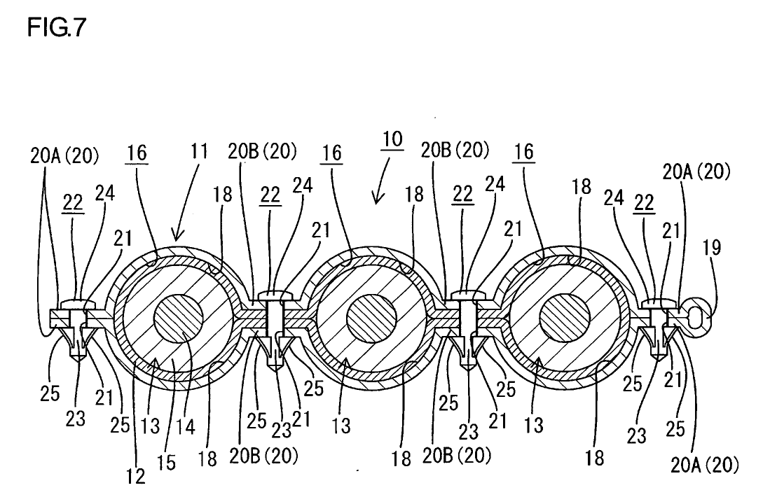

As shown in FIG. 7, the wire 13 is constituted by enwrapping the outer circumference of a core wire 14 made of metal (for example, such as aluminum alloy and copper alloy) with an insulating coating 15 made of synthetic resin (for example, such as polypropylene and polyethylene). The wire 13 according to the present embodiment is a non-shielded type. Regarding the cross-sectional shape of the wire 13, the cross-section of both the core wire 14 and the insulating coating 15 are circular as shown in FIG. 7. Though not shown in details, the core wire 14 is composed of a twisted wire spirally twisting a plurality of thin wires or a rod-shaped single core wire.

As shown in FIG. 1, the braided wire 12 forms a tubular shape as a whole. This braided wire 12 is constituted by weaving a metal thin wire into meshes. Three wires 13 are collectively enwrapped by the braided wire 12. The braided wire 12 is capable of stretching in the radial direction as well as the length direction due to the flexibility of the metal thin wire.

As shown in FIG. 1, provided in the sleeve pipe 11 are the first housing members 16 extending in the axial direction of the wire 13 (in a direction from the left front side to the right back side in FIG. 1). Each housing member 16 is arranged in a row in a direction perpendicular to the extending direction of the wire 13 (in a direction from the right front side to the left back side in FIG. 1) at intervals. Three wires 13 enwrapped by the braided wire 12 are separately housed in each housing member 16 (see FIG. 7). This allows each wire 13 to be housed in the sleeve pipe 11 in a row in a direction perpendicular to the axial direction of the wire 13 at intervals.

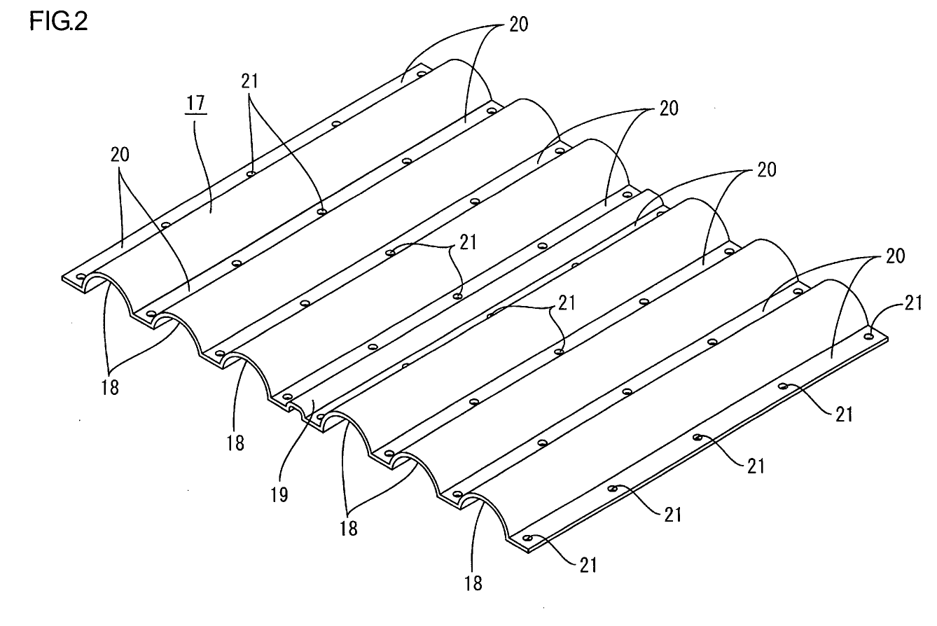

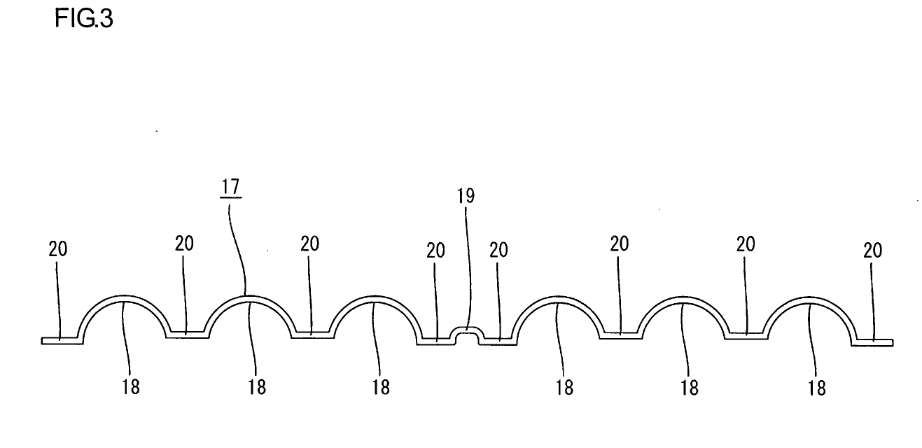

As shown in FIGS. 2 to 7, the sleeve pipe 11 is formed by folding a plate member 17 made of synthetic resin. As a synthetic resin, for example, materials relatively having rigidity, such as polyethylene, polypropylene, PET, PBT, and nylon may be used. The plate member 17 is formed by a known method (for example, extrusion). As shown in FIG. 2, formed in the plate member 17 in a row in a direction from the right front side to the left back side are six grooves 18. Each groove 18 is formed in a manner so as to extend from the left front side to the right back side in FIG. 2. As shown in FIG. 3, each groove 18 is formed in a manner so as to be recessed in some degree upwardly in FIG. 3, and its cross-sectional shape is semicircular.

In the plate member 17, a folding member 19 for folding the plate member 17 is formed in the near-center in the right and left direction in FIG. 3 in a manner so as to be recessed upwardly in FIG. 3. This folding member 19 is formed in a manner so as to extend along the extending direction of the groove 18 (in FIG. 2, from the left front side to the right back side).

As shown in FIG. 7, each groove 18 is formed in a position opposing each other when the plate member 17 is folded at the folding member 19. Between the grooves 18 opposing each other, a spacing having a circular cross-sectional shape is formed. The wire 13 and the braided wire 12 are housed inside of this spacing, and thus the above-mentioned housing member 16 is constituted. The radius of the inner circumferential surface of the groove 18 is designed so as to be slightly smaller than the one obtained by adding the thickness of the braided wire 12 to the radius of the outer circumferential surface of the insulating coating of the wire 13.

In the sleeve pipe 11, an opposing wall 20 opposing each other is formed in both the right and left side of each housing member 16 in FIG. 7. Among the opposing walls 20, first opposing walls 20A provided in the places closest to the right and left end of the sleeve pipe 11 in FIG. 7 abut each other from above and below. In addition, among the opposing walls 20, second opposing walls 20B provided near the center in the right and left direction of the sleeve pipe 11 in FIG. 7 oppose each other with a spacing therebetween, in a state of the braided wire 12 held between the opposing walls 20. This spacing is designed so as to be slightly smaller than twice of the thickness of the braided wire 12.

As shown in FIG. 2, multiple insertion holes 21 are formed in the opposing wall 20 along the extending direction of the housing member 16 in a row at intervals, and penetrate through the opposing wall 20. As shown in FIG. 7, the insertion hole 21 is formed in a position such that, when the plate member 17 is folded at the folding member 19, the insertion hole 21 formed in the opposing wall 20 positioned upper side and the insertion hole formed in the opposing wall 20 positioned in the lower side correspond each other. This allows each insertion hole 21 to communicate vertically in FIG. 7, when the plate member 17 is folded at the folding member 19. Inserted vertically into this insertion hole 21 is a pin 22 (corresponding to the pressing member) made of synthetic resin. Though described later in details, this pin 22 presses the inner circumference of the housing member 16 toward the outer circumference of the wire 13. Additionally, the pin 22 inserted into the insertion hole 21 in near the center in the right and left direction in FIG. 7 penetrates through gaps in the metal thin wires composing the braided wire 12.

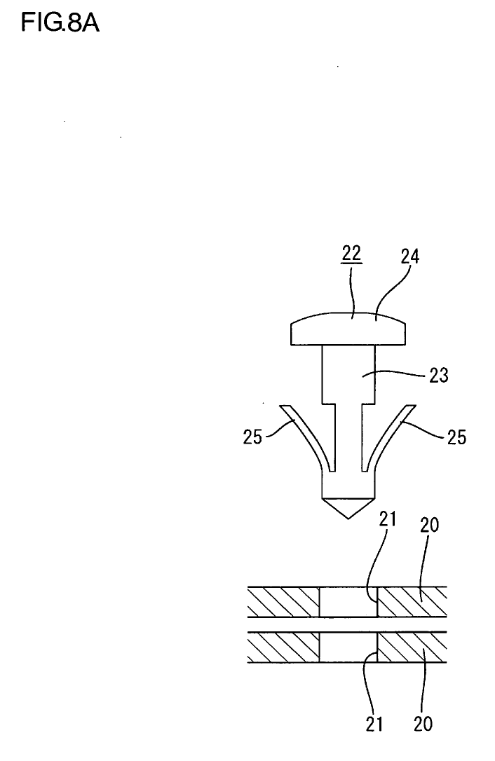

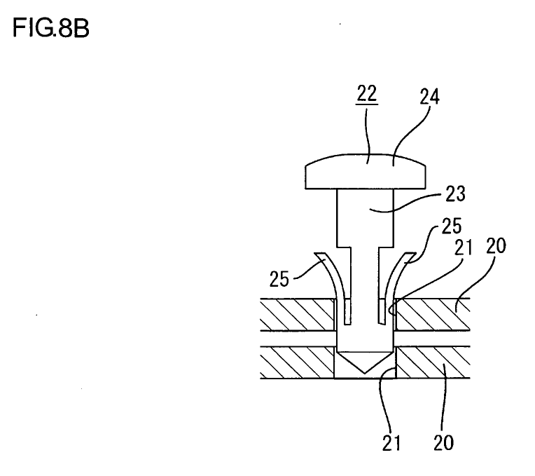

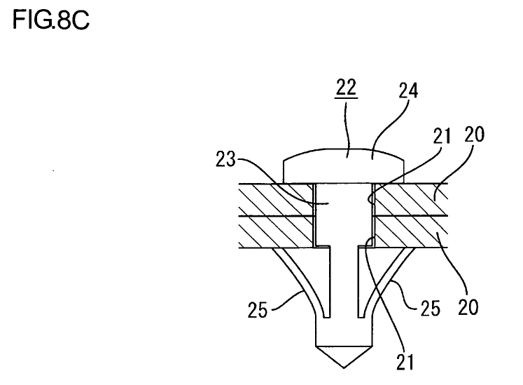

As shown in FIG. 8C, the pin 22 comprises an axis part 23 extending up and down in FIG. 8C and a flat part 24 positioned in the upper end of the axis part 23 and formed in a flat shape of a diameter larger than that of the axis part 23. In the axis part 23, from the position close to the lower end thereof, a pair of fall-out preventing pieces 25 is provided so as to extend diagonally upward left and upward right. The fall-out preventing piece 25 is capable of elastic deformation.

The axis part 23 of the pin 22 inserted into the insertion hole 21 that is positioned near the both right and left ends of the sleeve pipe 11 in FIG. 7 is designed so as to have a shorter height than that of the axis part 23 of the pin 22 inserted into the insertion hole 21 that is positioned near the center in the right and left direction of the sleeve pipe 11.

As shown in FIG. 7, with the pin inserted into the insertion hole 21 from up to down, the opposing walls 20 each other are held between the bottom surface of the flat part 24 of the pin 22 and the upper end of the fall-out preventing piece 25, and thereby fixed in a vertically pressed-state by elastic repulsive force of the fall-out preventing piece 25. This causes the groove 18 positioned upper side in FIG. 7 to be pressed downwardly and forced on the upper half of the outer circumference of the wire 13. On the other hand, the groove 18 positioned lower side in FIG. 7 is pressed upwardly and forced onto the lower half of the outer circumference of the wire 13. With this configuration, the inner circumference of the housing member 16 constituted by the grooves 18 is pressed toward the outer circumference of the wire 13. Accordingly, the braided wire 12 is held between the inner circumference of the housing member 16 and the outer circumference of the wire 13, and thus, the inner circumference of the first housing member 16 adheres tightly to the braided wire 12, while the braided wire 12 adheres tightly to the outer circumference of the wire 13.

Next, a manufacturing method of the shield conductor 10 according to the present embodiment is described. Firstly, the plate member 17 is formed by extruding a synthetic resin as shown in FIG. 2. The insertion hole 21 formed in the opposing wall 20 may be shaped at the time of extrusion, or be shaped by punching with a jig not shown after forming the plate member 17.

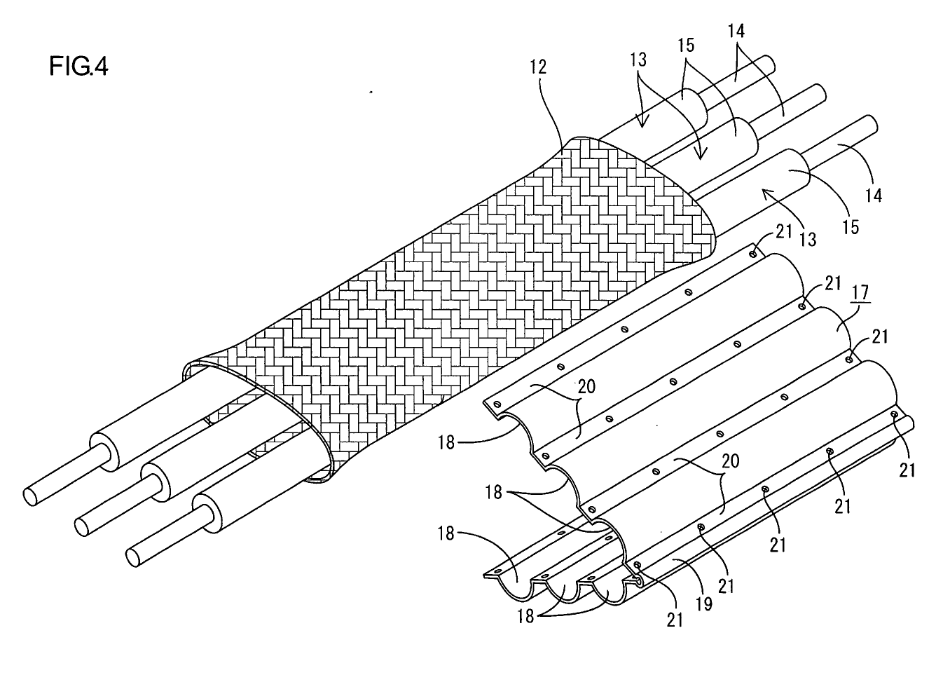

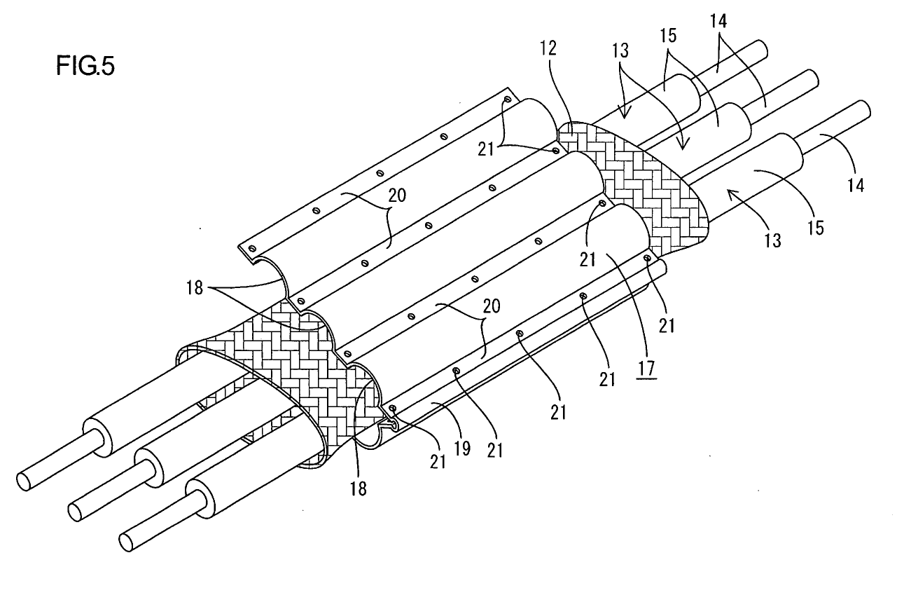

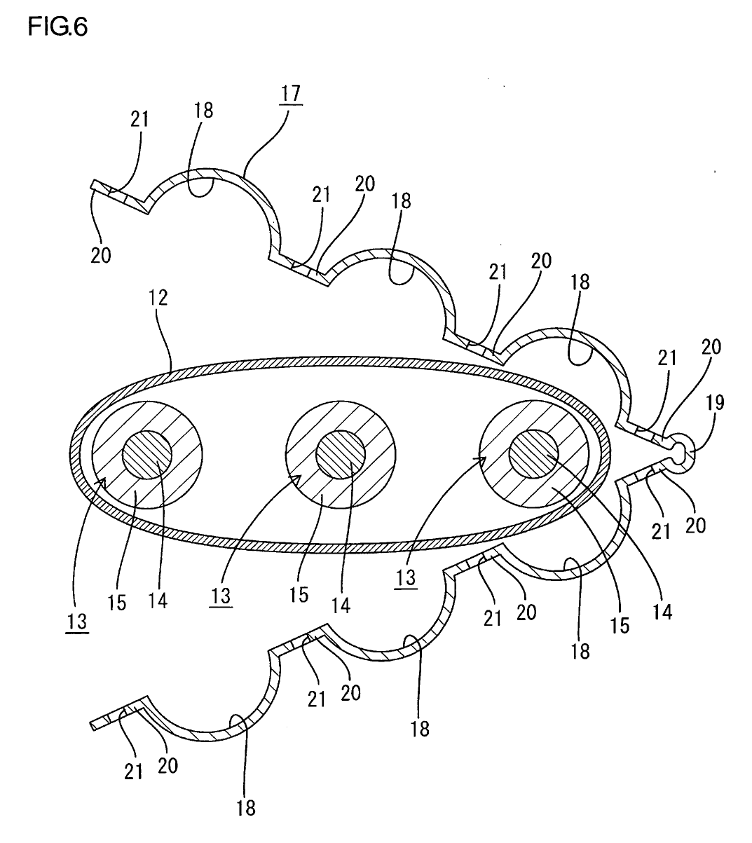

Next, as shown in FIG. 4, the wire 13 is run through inside of the braided wire 12. After that, as shown in FIGS. 5 and 6, the plate member 17 is folded at the folding member 19 so as to hold the wire 13 and the braided wire 12.

When the plate member 17 is folded at the folding member 19, the housing member 16 is formed by the grooves 18 formed in the plate member 17. The plate member 17 is folded so as to separately house the wire 13 within this housing member 16.

After that, as shown in FIGS. 8A, 8B, and 8C, the pin 22 is inserted into the insertion hole 21 in the opposing wall 20. From above the insertion hole 21 that is vertically communicating, the pin 22 is pushed downwardly, with its flat part 24 positioned upwardly (see FIG. 8A). When the lower part of the axis part 23 is inserted into the insertion hole 21, the fall-out preventing piece 25 provided in a position closer to the lower end of the axis part 23 is pressed by the inner circumferential surface of the insertion hole 21, and thereby elastically deforming in the closing direction of a pair of the fall-out preventing pieces 25 (see FIG. 8B). When the pin 22 is further pushed downwardly, a pair of the fall-out preventing pieces 25 recoveringly deforms in its opening direction (see FIG. 8C). Then, the bottom surface of the flat part 24 of the pin 22 and the upper surface of the opposing wall 20 positioned upper side are abutted on each other from above and below, while the upper end of the fall-out preventing piece 25 and the bottom surface of the opposing wall 20 positioned lower side are abutted on each other from above and below. This holds the opposing wall 20 between the flat part 24 and the fall-out preventing piece 25 in the pin 22. The opposing wall 20 is pressed vertically in FIG. 8C due to the elastic repulsive force of the fall-out preventing piece 25. Accordingly, the plate member 17 is fixed in a prevented-state of opening deformation in up and down direction. Accordingly, the shield conductor 10 is completed.

Next, working and effect of the present embodiment is described. Heat generated from the wire 13 when electrical current is fed to the wire 13 is transmitted from the wire 13 to the braided wire 12, and to the sleeve pipe 11, and then is released from the sleeve pipe 11 to the outside of the shield conductor 10. According to the present embodiment, the outer circumference of the wire 13 and the braided wire 12 tightly adhere each other, while the braided wire 12 and the inner circumference of the sleeve pipe 11 tightly adhere each other. Accordingly, the heat conductivity from the wire 13 to the sleeve pipe 11 can be improved, thereby improving the heat dissipation property of the shield conductor 10.

In addition, the braided wire 12 is constituted by weaving a metal thin wire, and an air layer exists in gaps of the metal thin wires in the braided wire 12. Therefore, heat is concerned to remain inside of the braided wire 12. In the present embodiment, the braided wire 12 adheres tightly to the wire 13 as well as to the sleeve pipe 11, so that heat generated from the wire 13 is transmitted directly from the wire 13 to the braided wire 12, and then directly from the braided wire 12 to the sleeve pipe 11. As a result, this can suppress heat from remaining within the braided wire 12.

Furthermore, according to the present embodiment, the inner circumference of the sleeve pipe 11 is pressed toward the outer circumference of the wire 13 by the pin 22. This enables the inner circumference of the sleeve pipe 11 and the braided wire 12, and also the braided wire 12 and the outer circumference of the wire 13, to be surely adhered each other.

Moreover, multiple of wires 13 are separately housed in the housing members 16 in the sleeve pipe 11, in a state aligned in a direction orthogonal to their axial direction at intervals. This can suppress heat generated from the wire 13 from remaining in between adjacent wires 13.

And also, multiple wires 13 are collectively shielded in the present embodiment, thereby achieving cost reduction.

Additionally, in the present embodiment, the sleeve pipe 11 is constituted by folding one plate member 17 at nearly the center and uniting thereof. This allows the sleeve pipe 11 to be formed from one plate member 17, and thereby achieving reduction in the number of parts.

Additionally, the sleeve pipe 11 is made of synthetic resin, and can be reduced in weight and production cost, in comparison with the sleeve pipe 11 made of a metal.

### Embodiment 2

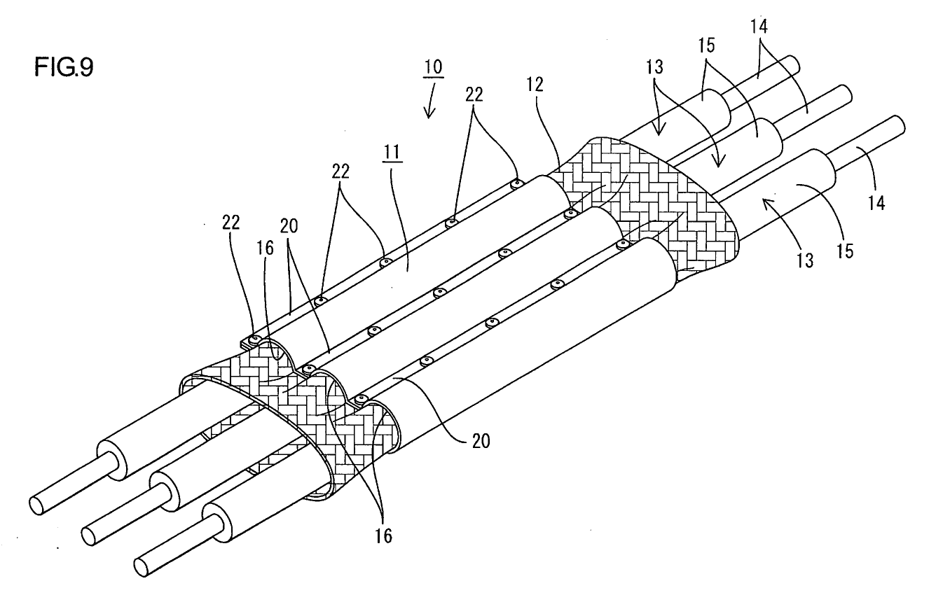

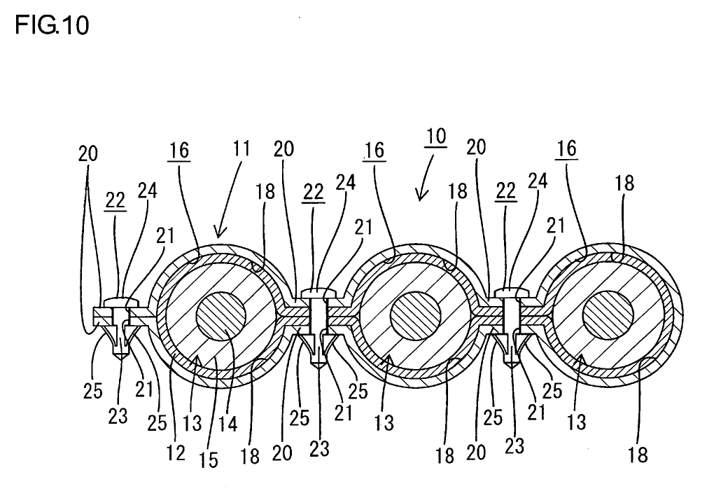

Next, in reference to FIGS. 9 and 10, Embodiment 2 of the present invention is described. In the present embodiment, unlike the shield conductor 10 according to Embodiment 1, the plate member 17 omits the folding member 19 and the opposing wall 20 provided in a manner so as to continue to the folding member 19. Accordingly, the pin 22 pressing and fixing the opposing walls 20 provided in a manner so as to continue to the folding member 19 in Embodiment 1 is also omitted.

In addition, the groove 18 formed in a position in the right end of the plate member 17 in FIG. 10 is vertically joined, with its cross-section in nearly a circular shape. The configurations other than the above are nearly the same as Embodiment 1, and thus, the same numerals are allotted to the same members, so that a repetitive description thereof is omitted.

According to the present embodiment, the folding member 19, the opposing wall 20 provided in a manner so as to continue to the folding member 19, and the pin 22 for fixing the opposing walls 20 can be omitted, and thereby simplifying the structure of the sleeve pipe 11.

### Embodiment 3

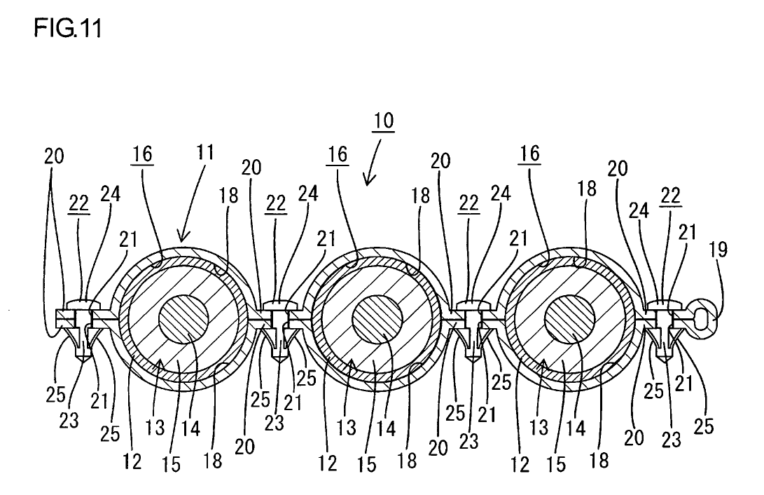

Next, in reference to FIG. 11, Embodiment 3 of the present invention is described. In the present embodiment, each wire has the insulating coating 15 enwrapping the outer circumference of the core wire 14, while the braided wire 12 enwraps the outer circumference of this insulating coating 15. This allows each wire 13 to be enwrapped separately by the braided wire 12.

The opposing wall 20 positioned in above and the opposing wall 20 positioned in below in FIG. 11 are vertically abutting. The vertical lengths of all the pins 22 inserted into the insertion holes 21 formed in the opposing wall 20 are designed to be the same.

The configurations other than the above are nearly the same as Embodiment 1, and thus, the same numerals are allotted to the same members so as to omit repetitive descriptions thereof.

In the present embodiment, an existing shielding wire can be used as the wire 13.

And also, the opposing walls 20 each other are abutting vertically, and not holding the braided wire 12 there between. Therefore, heat generated from the wire 13 does not remain in the gaps in the metal thin wires composing the braided wire 12. As a result, the heat dissipation property of the shield conductor 10 is improved.

### Embodiment 4

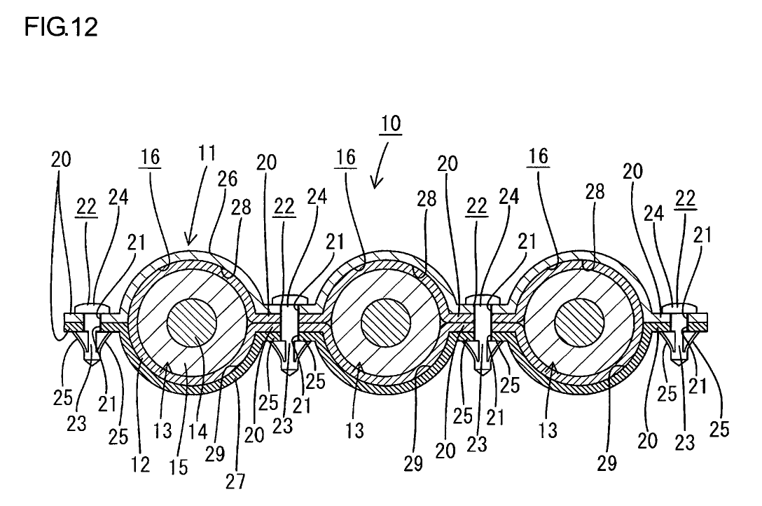

Next, in reference to FIG. 12, Embodiment 4 of the present invention is described. The sleeve pipe 11 is formed by uniting a first plate member 26 positioned above and a second plate member 27 positioned in below in FIG. 12. The first plate member 26 is made of synthetic resin, having three first grooves 28 aligned in the right and left direction in FIG. 12 and formed so as to be recessed upwardly. The cross-sectional shape of the first groove 28 is semicircular.

The second plate member 27 is made of synthetic resin, having three second grooves 29 aligned in the right and left direction and formed so as to be recessed downwardly. The cross-sectional shape of the second groove 29 is semicircular.

The first plate member 26 and the second plate member 27 are in the same shape, though illustrated as being inverted up and down in FIG. 12.

The first and the second grooves 28 and 29 are formed in positions opposing each other in a united state of the first plate member 26 and the second plate member 27. The opposing grooves 28 and 29 are forming the housing member 16 for housing the wire 13 and the braided wire 12.

The configurations other than the above are nearly the same as Embodiment 1, and thus, the same numerals are allotted to the same members so as to omit repetitive descriptions thereof.

According to the present embodiment, the sleeve pipe 11 can be formed from the first and second plate members 26 and 27 in the same shape, and thereby achieving cost reduction compared to the case where the sleeve pipe 11 is constituted by uniting plate members having different shapes.

### Other Embodiments

With embodiments of the present invention described above with reference to the accompanying drawings, it is to be understood that the invention is not limited to those precise embodiments, and the embodiments as below, for example, can be within the scope of the present invention.

(1) In Embodiment 4, both the first and the second plate members 26 and 27 are made of synthetic resin, however, the present invention is not limited to this, and for example, the first plate member 26 may be made of synthetic resin, while the second plate member 27 is made of a metal. In this case, when arranging the shield conductor 10 on, for example, the bottom surface (under the floor) of a vehicle, the second plate member 27 is provided as facing downward so as to protect the wire 13 from collision with foreign objects. Additionally, both the first and second plate members 26 and 27 may be made of a metal.
(2) In the present embodiment, the shielding layer is represented by the braided wire 12, however, the present invention is not limited to this, and the shielding layer may be formed by, for example, twisting a metallic tape around the outer circumference of the wire 13.
(3) As a pressing member, for example, a rivet may be used, and any members capable of pressing the inner circumference of the sleeve pipe 11 toward the outer circumference of the wire 13 may be used. Additionally, the sleeve pipe 11 is fixed by the pin 22 in Embodiment 3, however, the plate members may be united and fixed by heat sealing or an adhesive.
(4) In the present embodiment, the sleeve pipe 11 houses three wires 13, however, the present invention is not limited to this, and the sleeve pipe 11 may house multiple wires 13, two or four and more.

1-10. (canceled)

11. A shield conductor comprising: a wire, a shielding layer for enwrapping the outer circumference of the wire, and a sleeve pipe for housing the wire and the shielding layer,
wherein the outer circumference of the wire tightly adheres to the shielding layer, while the shielding layer tightly adheres to the inner circumference of the sleeve pipe.

12. The shield conductor according to claim 11 comprising a pressing member provided in the sleeve pipe so as to press the inner circumference of the sleeve pipe toward the outer circumference of the wire.

13. The shield conductor according to claim 12 wherein multiple housing members for separately housing the multiple wires are formed in the sleeve pipe in a row in a direction orthogonal to the axial direction of the wires at intervals.

14. The shield conductor according to claim 13 wherein the shielding layer is collectively enwrapping the multiple wires.

15. The shield conductor according to claim 13 wherein the shielding layer is separately enwrapping the multiple wires.

16. The shield conductor according to claim 11 wherein multiple housing members for separately housing the multiple wires are formed in the sleeve pipe in a row in a direction orthogonal to the axial direction of the wires at intervals.

17. The shield conductor according to claim 16 wherein the shielding layer is collectively enwrapping the multiple wires.

18. The shield conductor according to claim 16 wherein the shielding layer is separately enwrapping the multiple wires.

19. The shield conductor according to claim 11 wherein the sleeve pipe is constituted by folding one plate member at nearly the center and uniting thereof.

20. The shield conductor according to claim 19, wherein the sleeve pipe is constituted by uniting the plate members by heat sealing or an adhesive.

21. The shield conductor according to claim 20, wherein the sleeve pipe is made of synthetic resin.

22. The shield conductor according to claim 11, wherein the sleeve pipe is constituted by uniting two plate members, a housing member for housing the wire is formed in the sleeve pipe, the housing member is composed of a groove provided in each of the plate members, and the cross-section of the groove in the plate member is a semicircular shape.

23. The shield conductor according to claim 22 wherein at least one plate member among the two plate members is a metallic plate.

24. The shield conductor according to claim 23, wherein the sleeve pipe is constituted by uniting the plate members by heat sealing or an adhesive.

25. The shield conductor according to claim 11, wherein the sleeve pipe is made of synthetic resin.
